(19) United States
(12) Patent Application Publication
(10) Pub. No.: US 2009/0138271 A1
(43) Pub. Date: May 28, 2009

(54) PARAMETRIC AUDIO CODING COMPRISING AMPLITUDE ENVELOPS

(75) Inventors: Mads Graesboll Christensen, Noerresundby (DK); Steven Leonardus Josephus Dimphina Elisabeth Van De Par, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,013

(22) PCT Filed: Oct. 28, 2005
(86) PCT No.: PCT/IB05/53530

§ 371 Date: Apr. 26, 2007

(30) Foreign Application Priority Data
Nov. 1, 2004 (EP) 04105428.9

(51) Int. Cl. G10L 19/00

(52) U.S. Cl. 704/500; 704/E19.001

(57) ABSTRACT

An audio encoder comprising a sinusoidal type encoder and an amplitude modulation encoder that both receive an audio input signal. The amplitude modulation encoder generates a set of sinusoidal components each having assigned individual parameter(s) relating to a time-varying amplitude envelope. The sinusoidal type encoder may be a conventional constant amplitude type encoder and generate a set of constant sinusoidal components. Based on an optimisation using a predetermined encoding efficiency criterion, such as a perceptually relevant criterion, the audio encoder decides which components from the two encoders to be included in an output bit stream. In a preferred embodiment only components from one of the two encoders are used. Preferably, the optimisation process is repeated for each audio signal segment, and preferably a flag for each segment is included in the bit stream indicating if amplitude envelope parameters are present in the segment or not. The invention in addition relates to an audio decoder, methods of encoding and decoding as well as an encoded signal and devices comprising an encoder and a decoder. Audio coding according to the invention provides a high sound quality for transient sounds echo effects while it is still hit rate efficient since amplitude envelopes are included only if proven rate efficient.

The invention relates to the field of high quality low bit rate audio signal coding. Especially, the invention relates to audio coding based on parametric coding and adapted to effective coding and high sound quality in case of transient sounds. More specifically, the invention relates to a combined coding based on amplitude modulated and constant amplitude sinusoids.

A classic problem in audio coding is pre-echo distortion, i.e. errors occurring before onsets. These errors are very poorly masked by the human auditory system compared to the situation when a masker is present. Thus, quantization errors occurring before transients are very likely to cause clearly audible distortion. Consequently, special care must be taken to properly code transient sounds.

Pre-masking can be measured to typically last only about 20 ms, whereas post-masking can last longer than 100 ms. In addition, it should be noted that the masking phenomena occur on a critical band basis, i.e. they can not be precisely dealt with on a wideband basis. A large class of audio coding techniques such as sinusoidal coders, model the audio signal with components that are stationary over 10-20 ms. Many components are then needed to model short duration transients.

Within parametric audio modelling and coding, amplitude modulated sinusoidal models are of interest for capturing the features of transient sounds, such as those encountered in the excerpts “Glockenspiel” and “Castanets”. Damped sinusoids, for example, have received some attention for this purpose in the context of audio modelling.

Examples of prior art solutions using amplitude modulation in audio coding are “Analysis/Synthesis Audio Codec for Very Low Bit Rates” by B. Edler, H. Purnhagen and C. Ferekidis (100th Conv. Audio Eng. Soc. preprint 4179, 1996) and “Advances in parametric coding for high-quality audion” by Schuijers, Oomen, den Brinker and Gerrits (Proc. 1st IEEE Benelux Workshop on Model Based Processing and Coding of Audio (MPCA-2002)). These are, however, single-banded in their definition, detection and encoding of transients, meaning that the envelope is the same for all components. In “Analysis/Synthesis Audio Codec for Very Low Bit Rates”, though, it is decided per component whether to apply an estimated envelope.

The mentioned prior art examples suffer from the disadvantage that window length or estimation of amplitude modulating signal may be dominated by a strong stationary low frequency component while a weaker transient occurs at high frequencies thus causing audible artefacts. Another disadvantage is that a short window length is chosen due to the presence of a high frequency transient thus causing a poor frequency resolution to reduce audible quality of a stationary low frequency signal part.

It may be seen as an object of the present invention to provide an amplitude modulated sinusoidal audio coder, which is efficient in terms of rate-distortion, meaning that at a given bit rate, it achieves a lower distortion compared to a traditional sinusoidal coder, and is efficient also in terms of complexity, and at the same time it can handle transient sound without severe audible artefacts.

According to a first aspect of the invention, this object is complied with by providing an audio encoder adapted to encode an audio signal, the audio encoder comprising

a sinusoidal type encoder adapted to generate a first encoded signal part comprising a first plurality of sinusoidal components, and

an amplitude modulation encoder adapted to generate a second encoded signal part comprising a second plurality of sinusoidal components being individually assigned with at least one parameter relating to a time-varying amplitude envelope,

wherein the audio encoder comprises means adapted to evaluate the first and second encoded signal parts with respect to a predetermined encoding efficiency criterion and generate an encoded output signal in response thereto.

An encoder according to the first aspect provides a high encoding efficiency also for transient audio signals. The reason is that the amplitude modulation encoder is adapted to assign amplitude envelope parameter(s) to each individual sinusoidal component, preferably also within one segment. Thus, the audio encoder is capable of precisely representing transient audio signals since it can make some sinusoidal components change considerably over time, while others may be constant or almost constant. Hereby transient signals can be represented in a manner so that clearly audible pre-echo effects can be avoided or at least substantially reduced. This is an advantage over prior art encoders.

An encoder according to the first aspect is also efficient since encoding efficiency of an audio input signal is evaluated both with respect to a sinusoidal type encoder and an amplitude modulation encoder, the sinusoidal type encoder preferably being a conventional constant amplitude type encoder. Thus, extra bit rate to represent parameters relating to time-varying amplitude envelopes of each sinusoidal component is only used when it has been evaluated to be efficient in terms of some predetermined encoding efficiency criterion. Preferably, the efficiency criterion comprises a perceptually relevant distortion measure. In a preferred embodiment the efficiency criterion comprises a combination of a total bit rate and a perceptual distortion measure. Using a perceptual distortion measure a perceived sound quality can be considered in deciding whether amplitude modulation parameters should be included in the encoded output signal.

In a preferred embodiment the audio encoder is adapted to select one of the first and second encoded signal parts to be included into the encoded output signal. Preferably, it is decided, based on the encoding efficiency evaluation, whether the audio signal should be encoded by the sinusoidal type encoder or by the amplitude modulation encoder. Such decision may include the task of comparing a distortion measure for the two encoders under the constraint of a target bit rate and then select the one providing the lowest distortion. Instead of using the distortion measure directly, a cost function may be defined and the alternative with the lowest costs is selected. The cost function may comprise a linear combination of bit rate and perceptual distortion.

Alternatively, the audio encoder may consider a mix of sinusoidal components from the sinusoidal encoder and the amplitude modulation encoder. This may lead to an even more efficient encoding representation. However, the task is more complex.

Preferably, the encoder is adapted to evaluate encoding efficiency of the first and second encoded signal parts and generate an encoded output signal in response thereto for each segment of the audio signal. For rapidly changing signal such as transients it is important to treat the audio input signal on a segment-to-segment basis since a single transient will normally occur in only one or two segment, and consequently it is important with respect to encoding efficiency that the amplitude modulation encoder is only used where necessary, namely in segments where it is found to be efficient in terms of the predetermined encoding efficiency criterion. Otherwise bit rate is wasted on envelope parameter data for segments where it is not necessary.

Preferably, the amplitude modulation encoder is adapted to generate a time-varying amplitude envelope parameter relating to an attack of the time-varying amplitude envelope. The attack parameter may comprise a mathematical description of steepness of an amplitude envelope. In addition it may comprise an onset or attack time.

Preferably, the audio encoder is adapted to generate into its output bit stream a flag for each segment of the audio signal so as to indicate whether a time-varying amplitude information is included in the encoded output signal. Hereby a decoding device is informed whether to be ready to receive envelope parameter data or not.

Especially for embodiments where the audio encoder is adapted to generate an encoded output signal having a mix of constant sinusoidal components and sinusoidal components comprising amplitude envelope information, it may be preferred that the audio encoder is adapted to generate into its output bit stream a flag for each sinusoidal component whether it has amplitude envelope information or not.

According to a second aspect the invention provides an audio decoder adapted to decode an encoded audio signal, the audio decoder comprising:

means adapted to receive an encoded audio signal comprising a set of sinusoidal components being individually assigned with at least one parameter relating to a time-varying amplitude envelope, and

signal generation means adapted to generate an audio signal in response thereto.

Preferably, the decoder is adapted to receive in its input bit stream a flag indicating for each segment whether it contains amplitude envelope data or not.

In a third aspect the invention provides a method of encoding an audio signal comprising the steps of
generating a first encoded signal part comprising a first set of sinusoidal components,
generating a second encoded signal part comprising a second set of sinusoidal components being individually assigned with at least one parameter relating to a time-varying amplitude envelope,
evaluating the first and second encoded signal parts with respect to a predetermined encoding efficiency criterion, and
generating an encoded audio signal comprising parts of the first and second encoded signal parts based on a result of the evaluated encoding efficiency for the first and second encoded signal parts.

In a fourth aspect the invention provides a method of decoding an encoded audio signal comprising the steps of:

receiving a set of sinusoidal components,

receiving, for each individual sinusoidal component, at least one parameter relating to a time-varying amplitude envelope, and

generating an audio signal in response to the set of sinusoidal components and the individual time-varying amplitude envelopes.

In a fifth aspect the invention provides an encoded audio signal comprising

a set of sinusoidal components,

a set of at least one parameter relating to a time-varying amplitude envelope individually assigned to the sinusoidal components.

Preferably, the encoded audio signal comprises, for each segment, a flag indicating if the at least one parameter relating to the time-varying amplitude envelope is present or not. The encoded audio signal may in addition comprise a flag for each sinusoidal component indicating whether amplitude envelope parameter(s) is included for this component.

In a sixth aspect the invention provides a storage medium comprising data representing an encoded audio signal according to the fifth aspect. The storage medium is preferably a standard audio data storage medium such as DVD, DVDrom, DVD-r, DVD+rw, CD, CD-r, CD-rw, compact flash, memory stick etc. However, it may also be a computer data storage medium such as a computer harddisk, a computer memory, a floppy disk etc.

In a seventh aspect the invention provides a device comprising an audio encoder according to the first aspect.

In an eighth aspect the invention provides a device comprising an audio decoder according to the second aspect.

Preferred devices according to the seventh and eighth aspects are all different types of audio devices such as tape, disk, or memory based audio recorders and players. For example: solid state players, DVD players and recorders, audio processors for computers etc. In addition, it may be advantageous for mobile phones.

In a ninth aspect the invention provides a computer readable program code adapted to encode an audio signal according to the method according to the third aspect.

In a tenth aspect the invention provides a computer readable program code adapted to decode an encoded audio signal according to the method according to the fourth aspect.

The computer readable program code according to the ninth and tenth aspects may comprise software algorithms adapted for a signal processor, personal computers etc. and it may be present on a carriable medium such as a disk or memory card or memory stick, or it may be present in a ROM chip or in other way stored in a device.

In the following the invention is described in more details with reference to the accompanying figures, of which

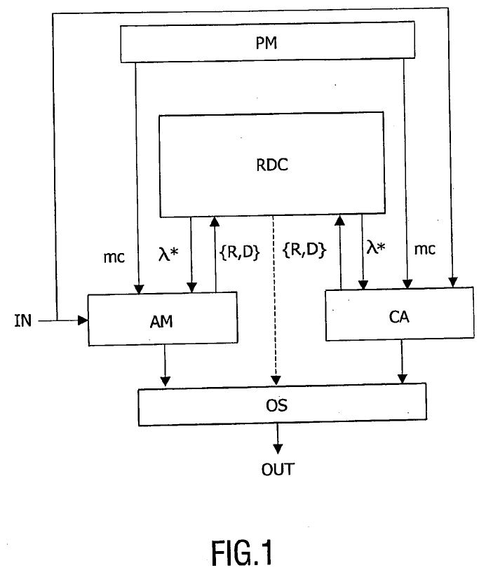

FIG. 1 shows a block diagram illustrating the principles of a preferred encoder embodiment comprising a sinusoidal encoder part and an amplitude modulation encoder part,

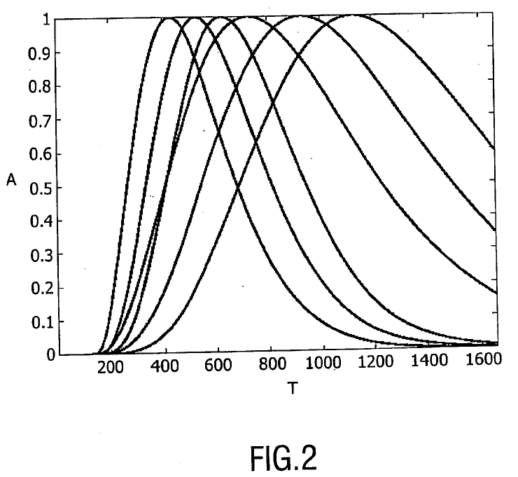

FIG. 2 illustrate examples of time-varying amplitude envelopes,

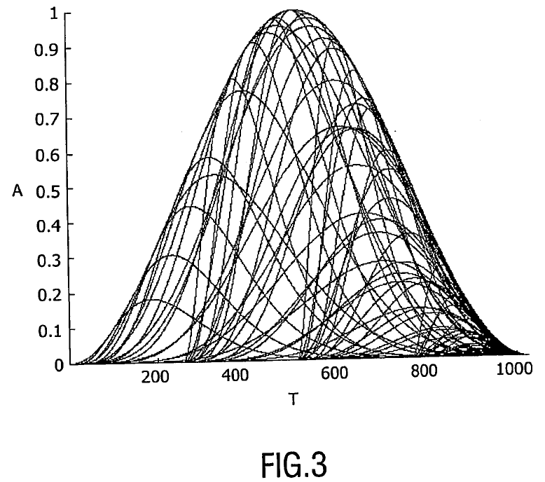

FIG. 3 illustrate examples of windowed gamma time-varying amplitude envelopes,

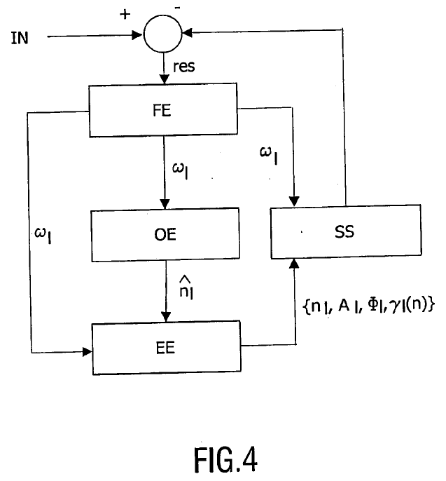

FIG. 4 illustrates a preferred algorithm for an iterative extracting of sinusoidal components in the amplitude modulation encoder part,

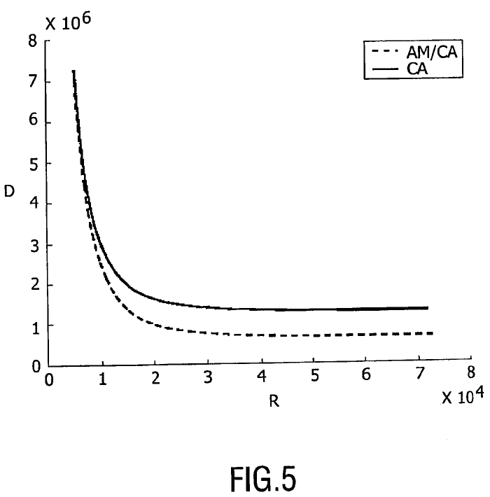

FIG. 5 shows an example of a graph indicating a difference in bit rate versus perceptual distortion for a sinusoidal encoder and for a combined sinusoidal and amplitude modulation encoder according to the invention, and

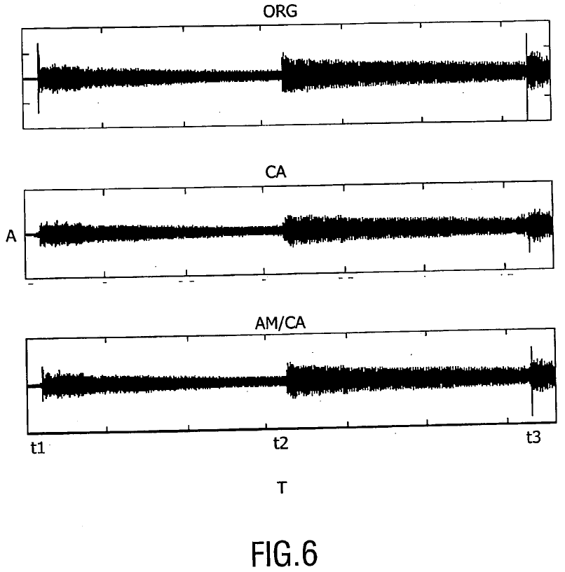

FIG. 6 illustrates an example of a time signals for an excerpt of bell sounds encoded with a sinusoidal encoder compared with a combined encoder according to the invention.

While the invention is susceptible to various modifications and alternative forms, specific embodiments have been shown by way of example in the drawings and will be described in detail herein. It should be understood, however, that the invention is hot intended to be limited to the particular forms disclosed. Rather, the invention is to cover all modifications, equivalents, and alternatives falling within the spirit and scope of the invention as defined by the appended claims.

FIG. 1 illustrates in block diagram of a combined encoder according to the invention. An audio signal IN is applied to a conventional sinusoidal encoder part CA and an amplitude modulation encoder part AM. Each of these encoders or subcoders CA, AM is capable of generating a set of sinusoidal components in response to the audio signal IN. The sinusoidal encoder CA operates in a conventional manner, i.e. as a constant amplitude sinusoidal encoder, whereas the amplitude modulation encoder AM extracts sinusoidal components each being assigned with individual time-varying amplitude envelopes described by one or more parameters, thus this costs extra bit rate since a representation of the selected amplitude modulation parameter for each sinusoidal component needs to be included into an output bit stream OUT. Further details regarding the amplitude modulation subcoder AM will be described in the following.

A rate distortion control unit RDC serves to select encoding templates for the two encoders CA, AM and evaluate their performance with respect to encoding efficiency according to an encoding efficiency criterion, e.g. by minimizing a cost function. A criterion may be optimisation of a perceptual distortion measure, i.e. optimisation of audible quality, under a constraint of a total target bit rate.

Each of the encoders CA, AM result in an amount of bit rate R and a distortion D of the audio signal IN. Based on these rates R and distortions D the rate distortion control unit RDC optimises a cost function based on the Lagrange multiplier, indicated by λ*, for each of the encoders CA, AM. Hereby it ends up with two results in terms of rate-distortion, and it selects the best one of the two encoders CA, AM to generate an encoded output signal provided in the output bit stream OUT. In FIG. 1 this selection between the two encoders CA, AM is illustrated by an output switch OS controlled by the rate distortion control unit RDC thus selecting which of the two encoders CA, AM to be active.

Preferably the selection between the sinusoidal encoder CA and the amplitude modulation encoder AM is performed for each segment of the audio signal IN. Hereby the best possibility to for the encoder to adapt to rapid variations of the audio signal IN, including transients present in the end of a segment. Preferably, the audio signal is split into overlapping segments.

In an alternative embodiment the encoder is adapted to generate an encoded representation of an audio signal comprising a mix of sinusoidal components generated by the sinusoidal encoder and the amplitude modulation, i.e. an encoded signal comprising both sinusoidal components having constant amplitude as well as amplitude modulated sinusoidal components. This embodiment will preferably be adapted to generate in an output bit stream a flag indicating, for each sinusoidal component, whether amplitude modulation is applied. Preferably, this alternative embodiment will also be adapted to evaluate a rate-distortion efficiency on a segment-to-segment basis.

The individual time-varying amplitude envelopes for each sinusoidal component are described by means of at least one, preferably more parameters, such as onset time, attack rate, decay time etc. as will be described in more detail in the following.

Optionally, FIG. 1 shows a perceptual model unit PM adapted to calculate a representation of a masking curve mc based on the audio signal IN, i.e. generate a representation of the human auditory masking threshold given the audio signal IN. This masking curve mc is provided to the subcoders CA, AM so as to enable them to increase encoding efficiency since knowledge of the masking curve helps to provide a perceptually relevant distortion measure parameter, i.e. a distortion measure descriptive of perceived sound quality.

Further details regarding perceptual distortion relevant measure and background information about sinusoidal estimation may be found in “Sinusoidal modeling using psychoacoustical matching pursuits” by R. Heusdens, R. Vafin, W. B. Kleijn ((2002), IEEE Signal Processing Lett, 9(8), pp. 262-265) and “A new psychoacoustical masking model for audio coding applications” by S. van de Par, A. Kohlrausch, G. Charestan, R. Heusdens ((2002), IEEE Int. Conf. Acoust., Speech and Signal Process., Orlando, USA, 2002, pp. II-1805-1808) which are both hereby incorporated by reference.

Preferably, the amplitude modulation encoder AM is adapted to generate sinusoidal components according to:

$${x}^{̑} ( n ) = {\sum }_{l = 1}^{L} {γ}_{l} ( n ) {A}_{l} cos ( {ω}_{l} n + {φ}_{l} ) , \qquad ( 1 )$$

wherein n=1, . . . , N.

Aₗ, ωₗ and φₗ are amplitude, frequency and phase of the l′th sinusoidal component, respectively. γₗ(n) is the time-varying amplitude envelope of the l′th sinusoidal component. Allowing γₗ(n) to vary over time is denoted amplitude modulation. Preferably, the envelope is modeled as:

γₗ(n)=u(n−nₗ)(n−n₁)^{α}^{ₗ}e^{-β(n-n}^{ₗ}⁾ (2)

for transient components and

γₗ(n)=1, for all n, for stationary components.

Each envelope is characterized by an onset nₗ, an attack parameter αₗ, and a decay parameter βₗ. The unit step-function is denoted u(n).

FIG. 2 illustrates examples of time-amplitude plots for envelopes according to (2), called gamma-envelopes. It should be understood that the illustrated amplitude and time scales and other parameters are arbitrarily chosen merely to illustrate the shape of the curves generally characterised by a well-defined sharp onset and a slow decay.

By applying different time-varying gamma-envelopes of (2) to each sinusoidal component, a set of amplitude modulated sinusoids with individual modulation characteristics can be generated.

FIG. 3 illustrates time-amplitude plots of windowed amplitude envelopes, namely windowed gamma-envelopes. As for FIG. 2, the curves mainly serve to illustrate the general shapes. Preferably von Harm type windows are used.

FIG. 4 serves to illustrate a preferred iterative estimation procedure for the amplitude modulation encoder AM comprising three steps. An audio input signal IN is first estimated with respect to frequency of a first sinusoidal component FE, estimation of onset OE and finally envelope parameter estimation EE comprising a corresponding phase and amplitude. Sinusoidal components are then generated by sinusoidal synthesis SS according to the found parameters and then subtracted from the input signal IN. Thus, in this way a set of sinusoidal components are found one at a time and each time subtracted from the input signal IN until a predefined stop criterion is met.

In preferred embodiment phases of sinusoidal components are quantized uniformly using 5 bits, while amplitudes and frequencies are quantized in the logarithmic domain. For gamma envelopes it has been found that 8-10 bits/component produces good results with most of the bits being spent on an onset grid. In addition use of an envelope dictionary size of 8 bits has been found appropriate.

For the rate-distortion optimization process estimated mean rates are preferably used in determining rates of coding templates for the two encoders CA, AM. For the sinusoidal encoder CA approximately 16 bits/component is found appropriate while 24 bits/component is appropriate for the amplitude modulation encoder AM (assuming differential encoding).

FIG. 5 shows graphs illustrating encoding efficiency in terms of distortion D versus bit rate R for an excerpt of “Glockenspiel”, i.e. sound from bells. A standard sinusoidal encoder is shown with solid line, and a combined encoder according to the invention is shown with dashed line. It is clearly seen that a substantially lower distortion D is obtained at a given bit rate R with a combined encoder according to the invention, or alternatively a reduced bit rate R required to reach a certain sound quality (distortion D).

FIG. 6 illustrates, for an short excerpt of “Glockenspiel” a time signal, i.e. amplitude A versus time T. Upper part of the FIG. 6 shows the original signal ORG. Middle part of the FIG. 6 shows a standard sinusoidal encoder CA, while a combined encoder AM/CA according to the invention is shown in lower part of FIG. 6. As seen, the sinusoidal encoder completely misses the peak at time t1, and almost completely at t3. The onset at t2 is also not as sharp as in the original signal. Although not perfect, the combined encoder according to the invention is seen to better much reproduce the transients and onsets at times t1, t2 and t3 than the standard sinusoidal encoder.

Listening tests have confirmed that sound quality of low bit rate, e.g. 30 kbps, audio coding profits from a combined encoder according to the invention when compared to standard sinusoidal coding. Pre-echos are clearly reduced and transients are better modeled. Audio signal exhibiting fast onsets, impulse-like excitations, transitions between different types of signals like from voiced to unvoiced speech and percussive instruments.

A decoder adapted to decode a bit stream from an encoder according to the invention must be adapted, of course, to receive a number of time-varying amplitude envelope parameters and generate an according audio signal in response thereto.

As will be understood this invention may be applied within a large range of applications, such as storing devices in general, solid state audio devices, DVD players/recorders, mobile communication devices, multimedia streaming of audio such as on the internet etc.

In the claims reference signs to the figures are included for clarity reasons only. These references to exemplary embodiments in the figures should not in any way be construed as limiting the scope of the claims.

1. An audio encoder adapted to encode an audio signal (IN), the audio encoder comprising:
a sinusoidal type encoder (CA) adapted to generate a first encoded signal part comprising a first plurality of sinusoidal components, and
an amplitude modulation encoder (AM) adapted to generate a second encoded signal part comprising a second plurality of sinusoidal components being individually assigned with at least one parameter relating to a time-varying amplitude envelope,
wherein the audio encoder comprises means adapted to evaluate the first and second encoded signal parts with respect to a predetermined encoding efficiency criterion and generate an encoded output signal (OUT) in response thereto.

2. An audio encoder according to claim 1, adapted to select one of the first and second encoded signal parts to be included into the encoded output signal (OUT).

3. An audio encoder according to claim 1, adapted to evaluate encoding
efficiency of the first and second encoded signal parts and generate an encoded output signal in response thereto for each segment of the audio signal (IN).

4. An audio encoder according to claim 1, wherein the amplitude modulation encoder (AM) is adapted to generate a time-varying amplitude envelope parameter relating to an attack of the time-varying amplitude envelope.

5. An audio encoder according to claim 1, wherein the predetermined encoding efficiency criterion comprises a combination of a total bit rate and a perceptual distortion measure.

6. An audio encoder according to claim 1, adapted to generate into the encoded output signal (OUT) a flag for each segment of the audio signal (IN) so as to indicate whether time-varying amplitude information is included in the encoded output signal (OUT).

7. An audio encoder according to claim 1, adapted to generate into the encoded output signal (OUT) a flag for each segment and for each individual sinusoidal component of the encoded output (OUT) signal so as to indicate whether time-varying amplitude information is included.

8. An audio encoder according to claim 1, wherein the amplitude modulation encoder (AM) comprises means (SS) adapted to generate a sinusoidal component based on an iteration loop comprising estimation of frequency (FE), onset (OE) and envelope (EE) parameters of the sinusoidal component.

9. An audio decoder adapted to decode an encoded audio signal, the audio decoder comprising:
means adapted to receive an encoded audio signal comprising a set of sinusoidal components being individually assigned with at least one parameter relating to a time-varying amplitude envelope, and
signal generation means adapted to generate an audio signal in response thereto.

10. A method of encoding an audio signal comprising the steps of:
generating a first encoded signal part comprising a first set of sinusoidal components,
generating a second encoded signal part comprising a second set of sinusoidal components being individually assigned with at least one parameter relating to a time-varying amplitude envelope,
evaluating the first and second encoded signal parts with respect to a predetermined encoding efficiency criterion, and
generating an encoded audio signal comprising parts of the first and second encoded signal parts based on a result of the evaluated encoding efficiency for the first and second encoded signal parts.

11. A method of decoding an encoded audio signal comprising the steps of:
receiving a set of sinusoidal components,
receiving, for each individual sinusoidal component, at least one parameter relating to a time-varying amplitude envelope, and
generating an audio signal in response to the set of sinusoidal components and the individual time-varying amplitude envelopes.

12. An encoded audio signal comprising:
a set of sinusoidal components,
a set of at least one parameter relating to a time-varying amplitude envelope individually assigned to the sinusoidal components.

13. A storage medium comprising data representing an encoded audio signal according to claim 12.

14. A device comprising an audio encoder according to claim 1.

15. A device comprising an audio decoder according to claim 9.

16. A computer readable program code adapted to encode an audio signal according to the method of claim 10.

17. A computer readable program code adapted to decode an encoded audio signal according to the method of claim 11.
